(19) United States
(12) Patent Application Publication
(10) Pub. No.: US 2020/0286248 A1
(43) Pub. Date: Sep. 10, 2020

(54) STRUCTURED LIGHT SUBPIXEL ACCURACY ISP PIPELINE/FAST SUPER RESOLUTION STRUCTURED LIGHT

(71) Applicant: Samsung Electronics Co., Ltd., Suwon-si (KR)

(72) Inventor: Lilong Shi, Pasadena, CA (US)

(21) Appl. No.: 16/413,431

(22) Filed: May 15, 2019

Related U.S. Application Data
(60) Provisional application No. 62/815,928, filed on Mar. 8, 2019.

(51) Int. Cl. G06T 7/521; G06K 9/62; G06T 7/73; H04N 13/207; H04N 13/254

(52) U.S. Cl. CPC G06T 7/521; G06K 9/628; G06T 7/73; H04N 2013/0081; H04N 13/254; G06T 2207/30242; G06T 2207/10028; H04N 13/207

(57) ABSTRACT

A structured-light three-dimensional sensing system configured to project dots forming a structured light pattern including multiple unique patterns, configured to capture an image of an object, configured to recognize the dots, perceive the unique patterns, associate each pixel with the unique patterns, and assign a class ID representing a unique pattern and a subclass ID representing a portion of the unique pattern to each of the pixels, configured to count a number of neighboring pixels having the same assigned class ID, for each class ID, determine the pixel having a greatest number of neighboring pixels having the same assigned class ID as a center pixel, and, for each pixel belonging to a dot, re-arranging according to the pixel's sub-class ID, and configured to determine a disparity of each dot from a respective reference point, and to estimate a depth of a feature of the object.

### CROSS-REFERENCE TO RELATED APPLICATION(S)

This patent application claims priority to, and the benefit of, U.S. provisional patent application No. 62/815,928 entitled FAST SUPER RESOLUTION STRUCTURED LIGHT DEPTH IMAGE PROCESSING PIPELINE WITH SUBPIXEL PRECISION, filed on Mar. 8, 2019.

### FIELD

One or more aspects of embodiments of the present disclosure relate generally to a 3D-imaging system, such as a structured-light-based system, and to a method of generating three-dimensional data from a two-dimensional image using a structured light pattern.

### BACKGROUND

Conventional cameras and image sensors are configured to capture two-dimensional (2D) images of three-dimensional (3D) objects. The 2D representations of the 3D objects generally lack specific image information corresponding to depth of different points of the 2D image.

A type of 3D surface-imaging technology uses what is referred to as “structured light” to enable the acquisition of depth information based on analysis of the 2D image captured by the image sensor.

A projected structured light pattern, or “light coding” pattern, may be projected on an object by using a scanner, or projector, which may be at a fixed distance from the image sensor. The image sensor captures an image of the object with the structured light pattern projected thereon. A structured-light-based system connected to the image sensor (e.g., a processor of the system) is then able to analyze deformation of the structured light pattern caused by the contours of the object in the captured 2D image.

By analyzing the deformation of the structured light pattern, the structured-light-based system is able to calculate a depth map, or a disparity map. The analysis may include comparing the captured 2D image to a reference image corresponding to a projection of the structured light pattern on a flat surface.

Accordingly, 3D-surface imaging is enabled by calculating 3D coordinates, or by estimating depth, of various points on a surface of the 3D object represented in the 2D image.

### SUMMARY

Embodiments described herein provide improvements to 3D imaging technology, including structured-light-based systems, by enabling increased depth resolution.

According to one embodiment of the present disclosure, there is provided a structured-light three-dimensional sensing system including a light projector configured to project a plurality of dots onto an object, the dots collectively forming a structured light pattern including multiple unique patterns, an image sensor configured to capture an image of the object with the dots projected thereon, a patch classifier configured to analyze the image to recognize the dots, perceive the unique patterns of the structured light pattern based on the recognized dots, associate each pixel of the image with a respective portion of a corresponding one of the unique patterns, and assign a class ID and a subclass ID to each of the pixels of the image based on the perceived unique patterns, the class ID representing a respective unique pattern, and the subclass ID representing a respective portion of the unique pattern, a dot localizer configured to, for each pixel, count a number of neighboring pixels having the same assigned class ID as the pixel, for each class ID, determine the pixel having a greatest number of neighboring pixels having the same assigned class ID as being a center pixel corresponding to a center of a corresponding dot, and, for each pixel belonging to a dot, re-arranging according to the pixel's sub-class ID, and a depth estimator configured to determine a disparity of each dot from a respective reference point of the dot, and to estimate a depth of a feature of the object based on the determined disparity.

The dot localizer may be further configured to associate the center pixel with a respective N×N block of pixels, and reassign the class ID of each of the pixels of the block to match the class ID of the center pixel.

The dot localizer may be further configured to reassign the subclass ID to each of the pixels of the block of pixels based on its position in the block of pixels, and based on an order of the portions of the unique pattern represented by the class ID of the center pixel.

The structured light pattern may include 192 unique patterns, or 1024 unique patterns, or other configuration.

Each block of pixels may include a unique patch size of 3×3 pixels, or 4×4 pixels, or other configuration.

The light projector may be at a fixed baseline distance from the image sensor.

The dot localizer may be between the patch classifier and the depth estimator.

According to another embodiment of the present disclosure, there is provided a method of 3D imaging using a structured-light three-dimensional sensing system, the method including projecting, with a light projector, a plurality of dots onto an object, the dots collectively forming a structured light pattern including multiple unique patterns, capturing, an image sensor, an image of the object with the dots projected thereon, for each pixel, counting, with a dot localizer, a number of neighboring pixels having a same assigned class ID as the pixel, for each class ID, determining, with the dot localizer, the pixel having a greatest number of neighboring pixels having the same assigned class ID as being a center pixel corresponding to a center of a corresponding dot, and for each pixel belonging to a dot, re-arranging, with the dot localizer, according to the pixel's sub-class ID.

The method may further include associating, with the dot localizer, the center pixel with a respective N×N block of pixels, and reassigning, with the dot localizer, the class ID of each of the pixels of the block to match the class ID of the center pixel.

The method may further include reassigning, with the dot localizer, a subclass ID to each of the pixels of the block of pixels based on its position in the block of pixels, and based on an order of portions of the unique pattern represented by the class ID of the center pixel.

The structured light pattern may include 192 unique patterns, or 1024 unique patterns, or other configuration.

Each block of pixels may include a unique patch size of 3×3 pixels, or 4×4 pixels, or other configuration.

The light projector may be at a fixed baseline distance from the image sensor.

The method may further include estimating, with a depth estimator, a depth according to the equation Z=B×F/(P×D), wherein Z is the depth, B is a baseline distance between the light projector and the image sensor, F is a focal length of the image sensor, P is a pixel pitch, and D is a disparity.

According to yet another embodiment of the present disclosure, there is provided a non-transitory computer readable medium implemented on a structured-light three-dimensional sensing system, the non-transitory computer readable medium having computer code that, when executed on a processor, implements a method of 3D imaging using the structured-light three-dimensional sensing system, the method including projecting, with a light projector, a plurality of dots onto an object, the dots collectively forming a structured light pattern including multiple unique patterns, capturing, an image sensor, an image of the object with the dots projected thereon, analyzing, with a patch classifier, the image to recognize the dots, perceiving, with the patch classifier, the unique patterns of the structured light pattern based on the recognized dots, associating, with the patch classifier, each pixel of the image with a respective portion of a corresponding one of the unique patterns, assigning, with the patch classifier, a class ID and a subclass ID to each of the pixels of the image based on the perceived unique patterns, the class ID representing a respective unique pattern, and the subclass ID representing a respective portion of the unique pattern, for each pixel, counting, with a dot localizer, a number of neighboring pixels having the same assigned class ID as the pixel, for each class ID, determining, with the dot localizer, the pixel having a greatest number of neighboring pixels having the same assigned class ID as being a center pixel corresponding to a center of a corresponding dot, and determining, with a depth estimator, a disparity of each dot from a respective reference point of the dot, and to estimate a depth of a feature of the object based on the determined disparity.

The computer code, when executed by the processor, may further implement the method of 3D imaging using the structured-light three-dimensional sensing system by associating, with the dot localizer, the center pixel with a respective N×N block of pixels, and reassigning, with the dot localizer, the class ID of each of the pixels of the block to match the class ID of the center pixel.

The computer code, when executed by the processor, may further implement the method of 3D imaging using the structured-light three-dimensional sensing system by reassigning, with the dot localizer, the subclass ID to each of the pixels of the block of pixels based on its position in the block of pixels, and based on an order of the portions of the unique pattern represented by the class ID of the center pixel.

The structured light pattern may include 192 unique patterns, or 1024 unique patterns, or other configuration.

Each block of pixels may include a unique patch size of 3×3 pixels, or 4×4 pixels, or other configuration.

The light projector may be at a fixed baseline distance from the image sensor.

Accordingly, the structured-light-based system of embodiments of the present disclosure is able to achieve subpixel resolution, thereby increasing resolution and decreasing depth error, without adding any additional hardware to a conventional structured-light-based system.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The abovementioned and/or other aspects will become apparent and more readily appreciated from the following description of the embodiments, taken in conjunction with the accompanying drawings, in which:

FIG. 1 is an image of objects having a structured light pattern projected thereon by a projector, the image being captured by an image sensor, in a structured-light-based system, according to one or more embodiments of the present disclosure;

FIG. 2 is an example of the structured light pattern that may be projected by the projector of the structured-light-based system, according to one or more embodiments of the present disclosure;

FIG. 3 is a reference image of the structured light pattern, which is compared to the image of the objects of FIG. 1 to enable depth calculation of the surfaces of the objects, according to one or more embodiments of the present disclosure;

FIG. 4A is a block diagram of a structured light image signal processing (SL ISP) pipeline of a conventional structured-light-based system;

FIG. 4B is a block diagram of a structured light image signal processing (SL ISP) pipeline of a structured-light based system, according to one or more embodiments of the present disclosure;

FIG. 5 depicts a size of projected dots forming the structured light pattern and a size of pixels of the image sensor, according to one or more embodiments of the present disclosure;

FIGS. 6A-6D depict a method of dot localization and segmentation, according to one or more embodiments of the present disclosure;

FIG. 7 is an image of a bust having the structured light pattern projected thereon, which is used for both a comparative example and for an embodiment of the present disclosure;

FIG. 8A is a depth map depicting a depth classification of the area A of the test image of FIG. 7, according to a comparative example;

FIG. 8B is a depth map depicting a depth classification of the area A of test image of FIG. 7, according to an embodiment of the present disclosure;

FIG. 9A depicts a depth map resulting from depth calculation of the image of FIG. 7 by a conventional structured-light-based system, and depicts a corresponding graph showing the calculated disparity for a plurality of pixels in a selected row, according to a comparative example;

FIGS. 9B-9D each depict a depth map resulting from depth calculation of the image of FIG. 7 by a structured-light-based system, and depict a corresponding graph showing the calculated disparity for a plurality of pixels in the selected row, according to embodiments of the present disclosure;

FIG. 10A depicts a depth map resulting from depth calculation of an image of a flat board by a conventional structured-light-based system, according to a comparative example; and

FIGS. 10B-10D each depict a depth map resulting from depth calculation of the same image of the flat board by a structured-light-based system, according to embodiments of the present disclosure.

### DETAILED DESCRIPTION

Features of the inventive concept and methods of accomplishing the same may be understood more readily by reference to the detailed description of embodiments and the accompanying drawings. Hereinafter, embodiments will be described in more detail with reference to the accompanying drawings. The described embodiments, however, may be embodied in various different forms, and should not be construed as being limited to only the illustrated embodiments herein. Rather, these embodiments are provided as examples so that this disclosure will be thorough and complete, and will fully convey the aspects and features of the present inventive concept to those skilled in the art. Accordingly, processes, elements, and techniques that are not necessary to those having ordinary skill in the art for a complete understanding of the aspects and features of the present inventive concept may not be described. Unless otherwise noted, like reference numerals denote like elements throughout the attached drawings and the written description, and thus, descriptions thereof will not be repeated. Further, parts not related to the description of the embodiments might not be shown to make the description clear. In the drawings, the relative sizes of elements, layers, and regions may be exaggerated for clarity.

Various embodiments are described herein with reference to sectional illustrations that are schematic illustrations of embodiments and/or intermediate structures. As such, variations from the shapes of the illustrations as a result, for example, of manufacturing techniques and/or tolerances, are to be expected. Further, specific structural or functional descriptions disclosed herein are merely illustrative for the purpose of describing embodiments according to the concept of the present disclosure. Thus, embodiments disclosed herein should not be construed as limited to the particular illustrated shapes of regions, but are to include deviations in shapes that result from, for instance, manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the drawings are schematic in nature and their shapes are not intended to illustrate the actual shape of a region of a device and are not intended to be limiting. Additionally, as those skilled in the art would realize, the described embodiments may be modified in various different ways, all without departing from the spirit or scope of the present disclosure.

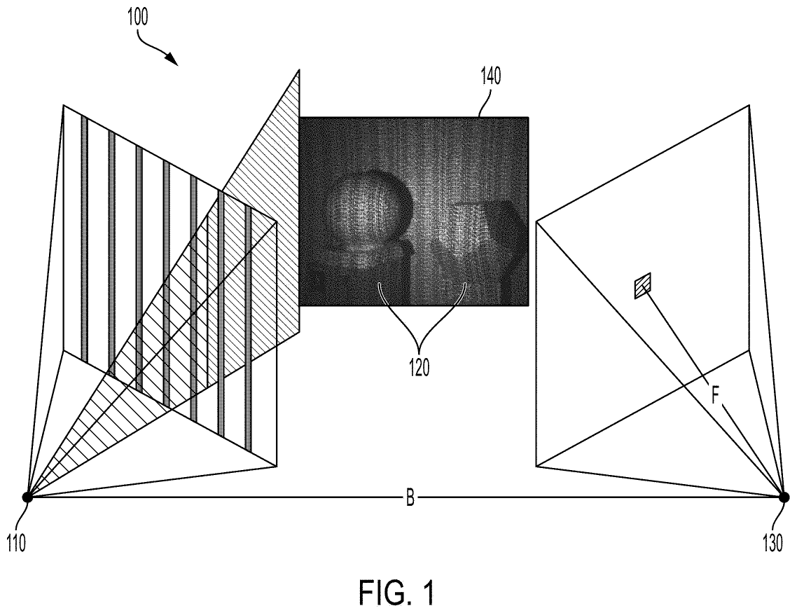

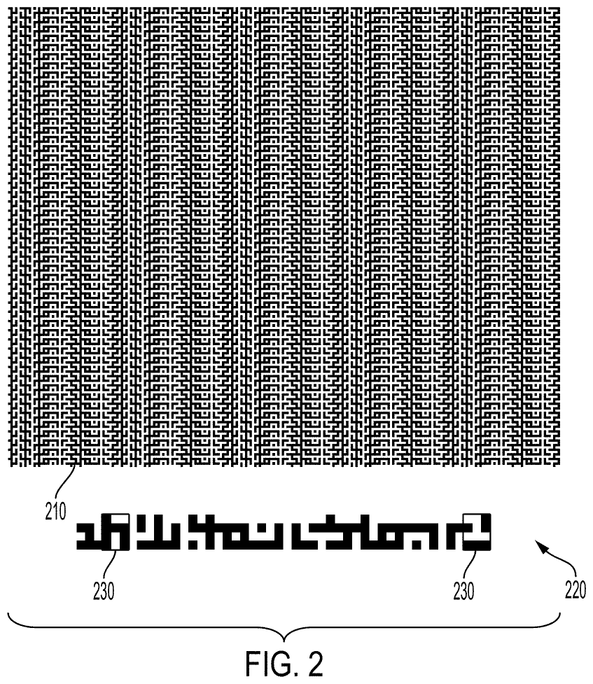

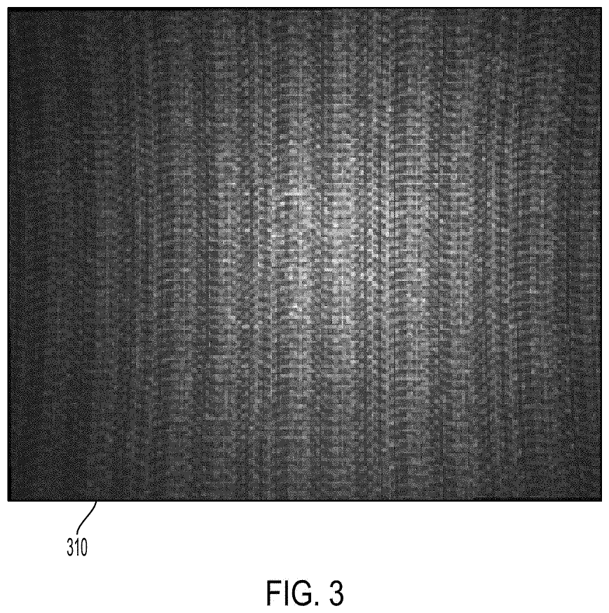

FIG. 1 is an image of objects having a structured light pattern projected thereon by a projector, the image being captured by an image sensor, in a structured-light-based system, according to one or more embodiments of the present disclosure, FIG. 2 is an example of the structured light pattern that may be projected by the projector of the structured-light-based system, according to one or more embodiments of the present disclosure, and FIG. 3 is a reference image of the structured light pattern, which is compared to the image of the objects of FIG. 1 to enable depth calculation of the surfaces of the objects, according to one or more embodiments of the present disclosure.

Referring to FIGS. 1, 2, and 3, a structured-light-based system 100 of an embodiment of the present disclosure includes a projector 110 (e.g., a structured-light 3D scanner) and an image sensor 130 (e.g., a camera). For example, the structured-light-based system 100 may be part of a handheld device (e.g., a smartphone, a cellphone, a tablet device, a digital camera, etc.). The structured-light-based system 100 uses what is referred to as “structured light,” or “coded light,” to enable the acquisition of depth information of one or more 3D objects 120.

The projector 110 may be an LCD projector or other stable light source. The projector 110 may include, for example, a laser diode or a light-emitting-diode (LED). The projector 110 is configured to project a unique structured light pattern on one or more objects 120.

The structured light pattern may correspond to the structured light pattern 210 shown in FIG. 2. The structured light pattern 210 may be within the visible spectrum of light, or may be in the infrared light spectrum. The structured light pattern 210 may be a repeating pattern 220 made of a plurality of patches 230 (e.g., 4×4 patches, as shown in FIG. 2). Accordingly, the projector 110 may project a plurality of dots collectively forming the structured light pattern 210. The projected dots will be discussed further below.

The image sensor 130 is offset from the projector 110 (e.g., slightly offset at a fixed distance, or baseline distance “B”). The image sensor 130 may have a focal length F, which may be a distance from a lens of the image sensor 130 to a sensing element of the image sensor 130. The image sensor 130 is configured to capture a 2D image 140 of the one or more objects 120 having the structured light pattern 210 projected thereon. The image sensor 130 may be, for example, an infrared image sensor or a general camera.

The structured-light-based system 100 may further include a processor. The processor may be communicatively coupled to the projector 110 and/or the image sensor 130. The processor may be a microprocessor, programed software codes, a dedicated integrated circuit, or some combination thereof. For example, the processor may operate according to codes implemented completely via software, via software accelerated by a graphics processing unit (GPU), or via a multicore system. The processor may include a dedicated hardware implemented for processing operations.

The structured-light-based system 100 (e.g., the processor) may have stored thereon a reference image of the structured light pattern 210, such as the reference image 310 shown in FIG. 3. The reference image 310 may be an image of the structured light pattern projected (e.g., by the projector 110) on a flat surface. The reference image 310 may be an image that was previously captured by the image sensor 130.

Because the projector 110 and the image sensor 130 are offset, the 3D surfaces of the one or more objects 120 cause corresponding locations of portions of the structured light pattern 210 to shift (e.g., in a horizontal direction) in the captured image 140, as compared to the respective locations of the portions of the structured light pattern 210 in the reference image 310. That is, respective degrees of deformation of different points of the structured light pattern 210 are caused by the projected structured light pattern 210 falling on the surface of the one or more objects 120.

By comparing and analyzing the 2D image 140 of the one or more objects 120 with the reference image 310, the processor of the structured-light-based system 100 is able to estimate the depth of the surfaces of the one or more objects 120 shown in the 2D image 140. For example, by counting a number of pixels in the image by which portions of the structured light pattern 210 have shifted, the structured-light-based system 100 (e.g., the processor) may estimate the depth of the surfaces, wherein the closer a portion of a surface of the one or more objects 120 is to the projector 110 and/or image sensor 130, the greater the degree of displacement of the portion of the structured light pattern 210 falling on that surface.

Accordingly, by using triangulation, the structured-light-based system 100 is able to estimate the depth of the surfaces of the objects 120 based on analysis of the 2D image 140 captured by an image sensor 130. That is, the structured-light-based system 100 is able to determine a shape of the one or more objects 120, and to calculate the distance, or the relative distances, of many points of the surfaces of the one or more objects 120 in the field of view of the image captured by the image sensor 130.

Accordingly, the structured-light-based system 100 (e.g., the processor) may generate a depth map based on the estimated depth of the different portions of the surfaces of the one or more objects 120 in the captured image 140.

For example, the structured-light-based system 100 may use triangulation to calculate depth “Z” according to Equation 1.

Z=B×F/(P×D) Equation 1

Where Z is the calculated depth or distance (e.g., a depth of a corresponding portion of the surface of the one or more objects 120), B is a baseline distance (e.g., the distance between the projector 110 and the image sensor 130), F is a focal length (e.g., a distance from a camera lens to the sensor within the image sensor 130), P is a pixel pitch (e.g., a distance between pixels of the image 140 generated by the image sensor 130), and D is an observed disparity (e.g., a distance by which the structured light pattern 210 has shifted due to the corresponding portion of the surface of the one or more objects 120, which may be observed by comparing the reference image 310 with the captured image 140 to determine a number of pixels by which the relevant portion of the structured light pattern 210 has shifted).

Accordingly, a depth resolution “ΔZ” (e.g., how small a change in depth can be perceived and represented) may be determined according to Equation 2.

ΔZ=k/ΔD Equation 2

Where k is a constant corresponding to the constraints of the structured-light-based system (e.g., the number and size of the pixels of the image), and ΔD is the change in disparity. In conventional systems, the change in disparity ΔD can be, at most, a single pixel.

Further, the depth error of a structured-light-based system may be determined according to Equation 3.

Depth Error=ΔZ/sqrt(12) Equation 3

Accordingly, resolution may be increased, and depth error may be decreased, by decreasing the change in disparity “ΔD.” If subpixel resolution, which corresponds to ΔD, is a fraction (e.g., ½ pixel disparity, ⅓ of a pixel disparity, ¼ pixel disparity, etc.), then a corresponding increase in depth resolution may be observed (e.g., 2×, 3×, 4×, etc., which may correspond to a depth resolution of 1 cm or less).

However, because the surface of a 3D object is generally nonplanar, it may be difficult to describe the surface in a 3D space using 3D surface imaging. Further, noise, disturbance, variation, etc. may lead to the incorrect calculation of depth of various points on the surface of the 3D object.

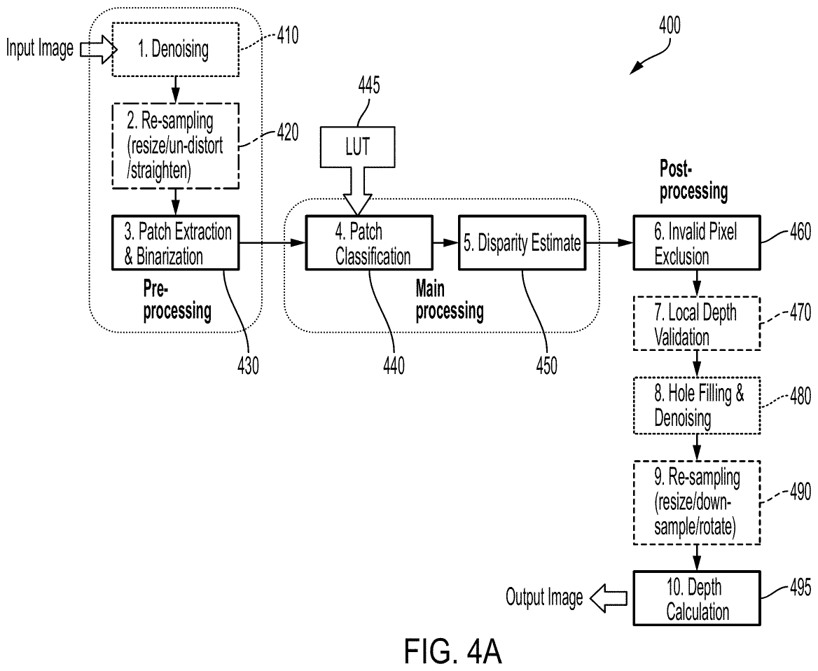

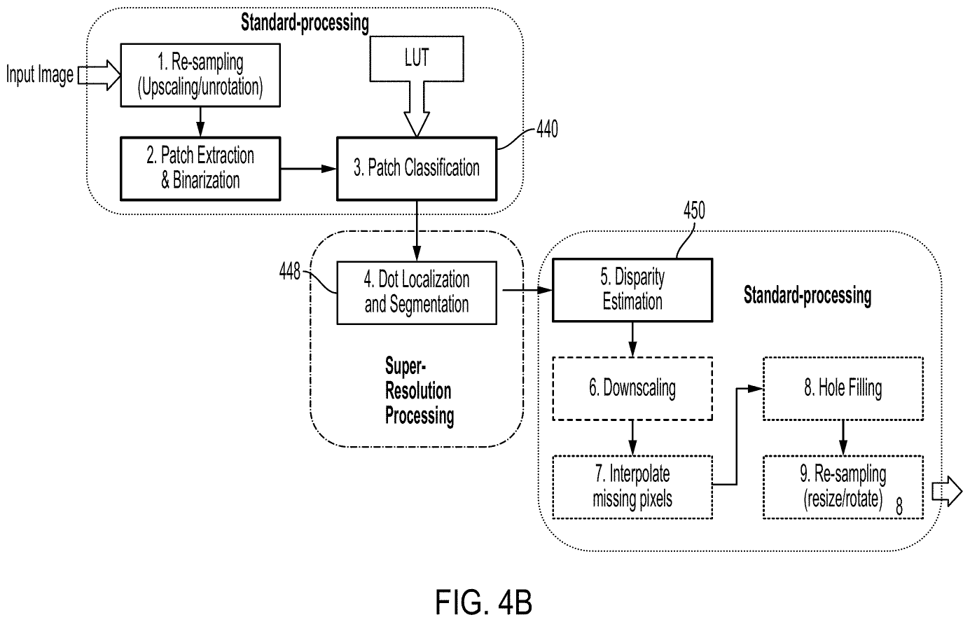

FIG. 4A is a block diagram of a structured light image signal processing (SL ISP) pipeline of a conventional structured-light-based system.

Referring to FIG. 4A, the SL ISP pipeline 400 of a conventional structured-light-based system includes three main stages. The three main stages may be referred to as pre-processing, main processing, and post processing.

First, during pre-processing of the SL ISP pipeline 400, when a 2D image (e.g., the image 140 of the one or more objects 120 shown in FIG. 1) is captured by the image sensor, the structured-light-based system may denoise the image (410). By denoising the image, the structured-light-based system may filter out random distortions perceived by the image sensor.

Then, the structured-light-based system may resample, or subsample, the denoised image (e.g., to resize, straighten, rotate, or reduce distortion) (420). That is, for subpixel resolution, the input image may be resized to a desired size. For example, if ½ subpixel resolution is sought to be achieved, the input grayscale image may be scaled by a factor of 2 in both horizontal and vertical directions; if ⅓ subpixel resolution is sought to be achieved, the input grayscale image may be scaled by a factor of 3 in both horizontal and vertical directions.

Then, the structured-light-based system may extract the structured light pattern made of the repeating patches (e.g., the structured light pattern 210), and may perform binarization (430). That is, for example, the structured-light-based system may recognize the structured light pattern that is captured in the image as being a part of a grayscale image. To enable processing, the structured-light-based system converts the portions of the grayscale image corresponding to the structured light pattern 210 to be either black or white. Accordingly, the structured light pattern 210 is more strongly represented, and can be more easily analyzed during processing.

Second, during main processing of the SL ISP pipeline 400 of a conventional structured-light-based system, the structured-light-based system conducts patch classification (440) using a lookup table (445) to classify the different portions of the structured light pattern as respective patches forming the structured light pattern (e.g., the different patches 230 that form the repeating pattern 220 that forms the structured light pattern 210).

The system then compares the respective locations of patches in the captured image to their respective locations in the reference image (e.g., by comparing the captured image 140 with the reference image 310).

Thereafter, based on the comparison of the respective locations of the light pattern in the captured image to those of the reference image, the structured-light-based system conducts disparity estimation (450) to determine to what degree each patch is shifted in the captured image from its original location as determined by the reference image (e.g., to calculate the observed disparity “D”).

In the structured light pattern 210 shown in FIG. 2, each patch 230 is 4×4. Although, the patch may be smaller in other embodiments of the present disclosure, it should be noted that, as the size of the patch is reduced, there will be a greater number of repetitions in the structured light pattern. Accordingly, the likelihood of misidentifying a patch may increase, thereby potentially making it difficult to determine which portion of the overall light pattern is being analyzed, in turn making it difficult to accurately determine the disparity.

Third, during post processing of the SL ISP pipeline 400 of the conventional structured-light-based system, the structured-light-based system may exclude invalid pixels (460), may perform local depth validation (470) based on perceived depth continuity of a surface of the object in the captured image, may conduct hole filling and denoising (480), and may conduct resampling (490) (e.g., resizing, down-sampling, and rotation) to further improve the image, thereby ultimately improving the accuracy of the calculations obtained during depth calculation (495).

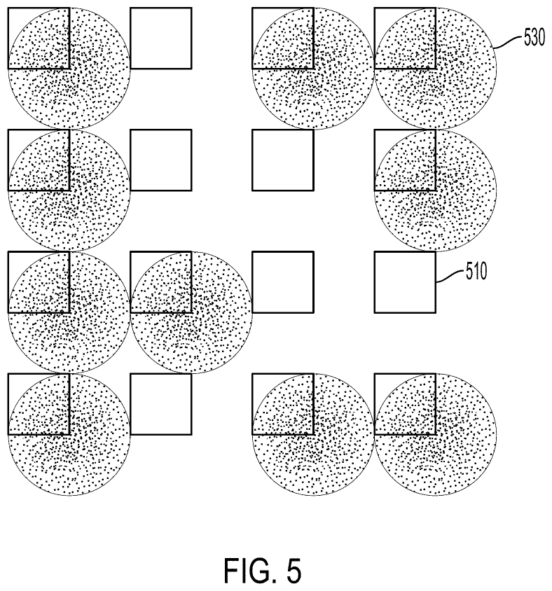

FIG. 4B is a block diagram of a structured light image signal processing (SL ISP) pipeline of a structured-light based system, according to one or more embodiments of the present disclosure, and FIG. 5 depicts a size of projected dots forming the structured light pattern and a size of pixels of the image sensor, according to one or more embodiments of the present disclosure.

Referring to FIG. 5, the main processing of the structured light ISP pipeline of a conventional structured-light-based system is unable to handle sub-pixel resolution. The reason for this inability is due to the pixels 510 of the image sensor being smaller than the projected dots 530 of light of the light pattern that is projected by the projector. Instead, the conventional system can only extract each 4×4 pixel patch by sparse-sampling, which is insufficient for sub-pixel location. For example, 4×4 patches at nearby locations may be perceived as being the same, thereby causing sub-pixel disparity ambiguity.

Referring to FIG. 4B, according to embodiments of the present disclosure, an additional operation of dot localization and segmentation 448 is added to the conventional SL ISP pipeline 400 between the operations of patch classification (e.g., with a patch classifier, or a patch classification module) 440 and disparity estimation 450. That is, the dot localization and segmentation 448 may occur after the operation of patch classification 440, as performing dot localization and segmentation 448 after patterns are classified may increase performance robustness, and may improve a final resulting depth map, thereby improving depth resolution. A “dot localization and segmentation” module 448 may be added to the SL ISP pipeline 400 of a conventional system without changes to the existing hardware of the conventional system. The dot localization and segmentation operation 448 enables increased resolution (i.e., sub-pixel resolution).

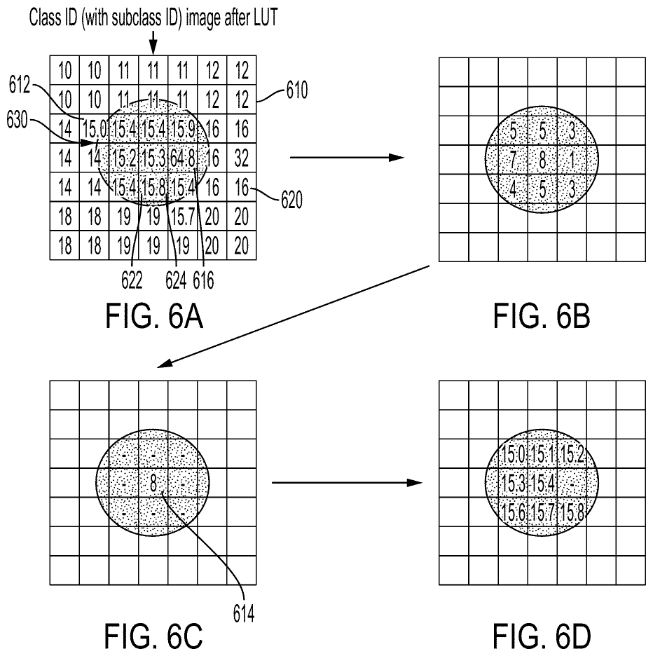

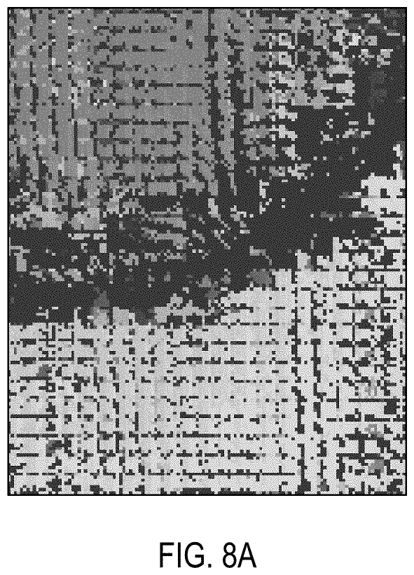

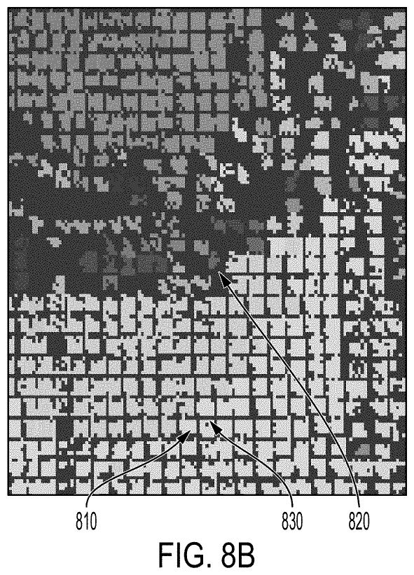

FIGS. 6A-6D depict a method of dot localization and segmentation, according to one or more embodiments of the present disclosure. In the present example, to achieve sub-pixel resolution, the captured image (e.g., the image 140 of FIG. 1) may be enlarged, and may be down-sampled to a fraction of the original size (e.g., during resampling, subsampling, or denoising the image (420) of the SL ISP pipeline 400 of FIG. 4A). In FIG. 5, one dot 530 corresponds to a 2×2 block of pixels 510. Although FIG. 5 shows the neighboring pixels as having space therebetween, in practice, the neighboring pixels may be close or even touching. A single dot 630 corresponds to a 3×3 block of pixels. However, in the present example, due to the resizing of the captured image, (e.g., see FIGS. 8A and 8B, described further below), a single dot 630 corresponds to a 6×6 block of pixels.

Referring to FIG. 6A, after patch classification (e.g., patch classification (440) shown in the SL ISP pipeline 400 of FIG. 4A), each pixel 610 of the captured image 140 may be assigned a respective index corresponding to a respective projected dot of a given unique patch 230 of the structured light pattern 210. In FIG. 6A, the index is represented by a reference character “620” so that it can be shown what the numbers illustrated inside of the pixels (e.g., numbers 10-20) represent. A projected dot 630 may correspond to a block of pixels. In the present example, a block of pixels comprises a 3×3 block of pixels.

Ideally, during patch classification (440), each pixel 610 of a 3×3 block of pixels would be assigned the same index 620 as the other pixels 610 of the same 3×3 block of pixels, while no two 3×3 block of pixels in the immediate vicinity would have the same index 620, noting that some blocks of pixels in the same image may have a same index 620 due to repetition of the structured light pattern 210, which is unique within a certain range in an epipolar-line direction. However, certain pixels may be misidentified during patch classification (440) (e.g., due to noise, distortion, etc.).

A projected dot 630 corresponding to a portion of a projected structured light pattern 210 may be projected on an object. The projected dot 630 may be captured by the image sensor 130. Accordingly, the structured-light-based system 100 (e.g., the processor) may sense a plurality of dots 630 collectively forming the structured light pattern 210 comprising a plurality of repeating unique patterns 220 formed of N×N patches 230 (N being an integer). Based on the structured-light-based system's analysis of the dots 630, the structured-light-based system 100 may identify each of the pixels 610 of the analyzed image with a predicted index 620, or identifier.

The index 620 may include a class ID 622, and a subclass ID 624. In the present example, the class ID 622 and subclass ID 624 are shown separated by a decimal (e.g., a class ID of “15” and a subclass ID of “8” is shown as “15.8”). The number of different class IDs may correspond to the number of unique patterns 220 present in the structured light pattern 210.

In the present embodiment, in a reference image 310 of the structured light pattern 210, each pixel 610 in a common block of pixels will have the same class ID 622, but will have a respective subclass ID 624 that is different from the other pixels 610 in its block. For example, in the present example, wherein each block of pixels includes 9 pixels 610, the subclass IDs 624 of the pixels 610 may range from 0-8.

Accordingly, the structured-light-based system 100 predicts the class ID 622 and the subclass ID 624 for each pixel 610 of the image 140 based on the structured light pattern 210 (e.g., of the reference image 310), and based on the detected dots 630. It should be noted that, although only some of the pixels are shown to have an assigned subclass ID 624 in FIG. 6A, the structured-light-based system 100 of embodiments of the preset disclosure may assign a subclass ID 624 for each pixel 610 of the image. That is, during patch classification (440), both a class ID 622 and a subclass ID 624 may be assigned to all of the pixels 610 of the captured image 140.

In the present example, the structured-light-based system 100 correctly identifies 8 of the 9 pixels 610 of the block of pixels corresponding to the dot 630 as corresponding to class ID “15,” and misidentifies one of the 9 pixel (the center right pixel 616 in the present example) as corresponding to an incorrect class ID (class ID “64” in the present example). For example, the misidentification may be caused by a corresponding local disturbance, a local variance, etc.

Furthermore, the structured-light-based system 100 misidentifies one pixel (i.e., pixel 612), which is adjacent to the block of pixels corresponding to the projected dot 630, and does not correspond to, the dot 630, as corresponding to class ID “15.”

Referring to FIG. 6B, the structured-light-based system 100 (e.g., the processor) counts the number of neighboring pixels 610 having the same class ID 622 for each pixel 610 (e.g., including the pixel 610 itself). A neighboring pixel, in the present example, is one of above, below, left, right, or in any diagonal direction to the pixel. In other examples, the neighboring pixels may be those pixels that would be in the same block of pixels as the reference pixel if the reference pixel was a center pixel of a pixel block. The neighboring-pixel counts are then assigned to the respective pixels.

Referring to FIG. 6C, based on the neighboring-pixel count generated by the structured-light-based system 100, as shown in FIG. 6B, the structured-light-based system 100 determines which pixel 610 has the highest count. The structured-light-based system 100 then identifies the pixel 610 with the highest count as corresponding to the center pixel 614 of the block of pixels. The center pixel 614 is used to determine the predicted center of the projected dot 630.

Accordingly, the structured-light-based system 100 is able to correctly identify the pixel 610 corresponding to the center of the dot 630. Then, the structured-light-based system 100 clears the class ID 622 and subclass ID 624 for each of the pixels 610 surrounding the center pixel 614, as represented by the “-” in the pixels 610 surrounding the center pixel 614.

Referring to FIG. 6D, the structured-light-based system 100 then renumbers all pixels 610 of the block to have the correct class ID 622, which matches that of the determined center pixel 614 (class ID “15” in the present example).

The structured-light-based system 100 also renumbers the subclass ID 624 of all pixels 610 of the block to be in order (e.g., 0 to 8). Accordingly, the block of pixels corresponding to the projected dot 630 is able to be correctly identified despite the initial misidentification of one or more pixels 610 of the block of pixels. In an embodiment of the present disclosure, pixels 610 of the block of pixels having a different class ID 622 than that of the center pixel 614 may be left as cleared/removed, such that the misidentified pixel(s) 616 remain blank for purposes of depth calculation.

After the renumbering of the pixels 610 for each block of pixels in the image 140, the structured-light-based system 100 may continue main processing to conduct disparity estimation (450) of each of the pixels.

Accordingly, as shown in FIGS. 6A-6D, the structured-light-based system 100 is able to correctly identify the block of pixels corresponding to the projected dot 630 by 1) counting, for each pixel 610, the number of neighboring pixels 610 having the same class ID 622 as the reference pixel, 2) locating the dot 630 center by identifying the pixel 610 having the greatest number of neighboring pixels 610 having the same class ID 622 thereas as the center pixel 614, 3) clearing the index for all pixels 610 of the block other than the center pixel 614, and 4) renumbering the cleared pixels 610 of the block to have the same class ID 622, and to have ordered subclass IDs.

Accordingly, the structured-light-based system 100 of the present embodiment is able to better identify dot 630 boundaries through dot 630 segmentation.

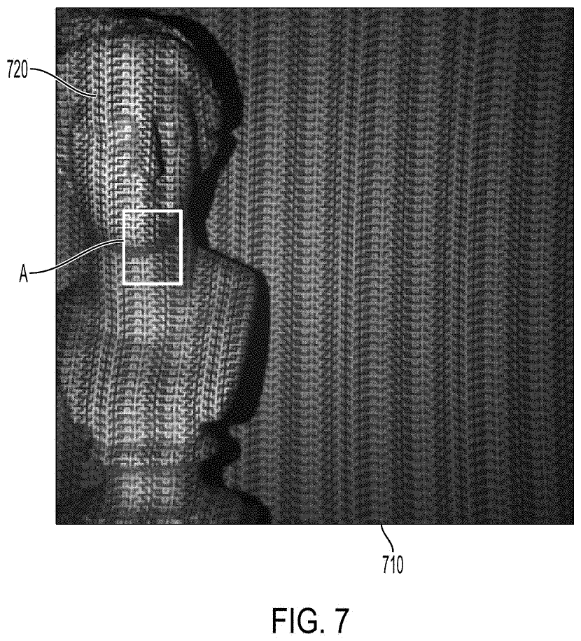

FIG. 7 is an image of a bust having the structured light pattern projected thereon, which is used for both a comparative example and for an embodiment of the present disclosure. FIG. 8A is a depth map depicting a depth classification of the area A of the test image of FIG. 7, according to a comparative example. FIG. 8B is a depth map depicting a depth classification of the area A of test image of FIG. 7, according to an embodiment of the present disclosure.

Referring to FIG. 7, a test image 710 of a bust 720 is used to demonstrate differences between the conventional system, which is incapable of subpixel resolution, and one or more embodiments of the present disclosure.

Referring to FIG. 8A, in the comparative example, super-resolution without dot-segmentation is performed on the captured image 710 of FIG. 7 (e.g., the image 710 is processed according to the SL ISP pipeline 400 of the conventional structured-light-based system shown in FIG. 4A).

In the calculated depth map, each pixel is assigned a color corresponding to the calculated depth of that portion of the object/bust of the image. In the present example, the orange color corresponds to a portion of the bust (the chin), and the yellow color corresponds to another portion of the bust (the neck). Further, the dark blue color corresponds to portions of the bust that are unable to be identified by the structured-light-based system (e.g., due to an inability to recognize the structured light pattern 210 at those portions of the bust). However, the present disclosure is not limited to the method of distinguishing different depths in the depth map. Accordingly, pixels assigned the orange color are determined to correspond to areas that are closer to the projector and the image sensor than the areas corresponding to the pixels assigned the yellow color.

However, random sub-disparities may occur within many of the projected dots corresponding to the light pattern, and dot boundaries may be ambiguous for some of the pixels of the depth map. Accordingly, and for example, pixels that are within, or that are directly adjacent to, blocks of orange pixels may be incorrectly assigned a color other than orange. A similar effect may be observed within or adjacent to blocks of yellow pixels.

Referring to FIG. 8B, in the present example of an embodiment of the present disclosure, the structured-light-based system analyzes the same image 710 analyzed by the conventional system that produced the comparative example of FIG. 8A.

In contrast to the comparative example of FIG. 8A, super-resolution with dot-segmentation is performed on the captured image 710 of FIG. 7. That is, by using the method described with respect to FIGS. 6A-6D, the centers of the projected dots are able to be detected, and noisy/ambiguous pixels are able to be cleaned up.

Accordingly, the projected dots 630 forming the structured light pattern 210 projected on the bust 720 are able to be segmented and flattened (e.g., see the block of pixels 810 corresponding to a segmented dot shown in FIG. 8B). Further, a depth value may be assigned to every single pixel in the image. However, dot boundaries may remain, and some areas of noise 830 may be ambiguous and unable to be segmented (e.g., see the unsegmented area of pixels 820 shown in FIG. 8B).

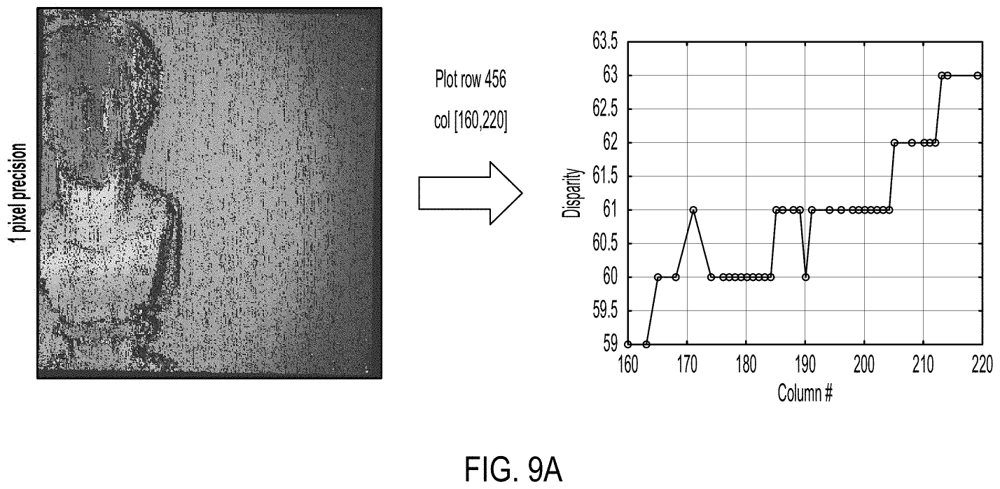

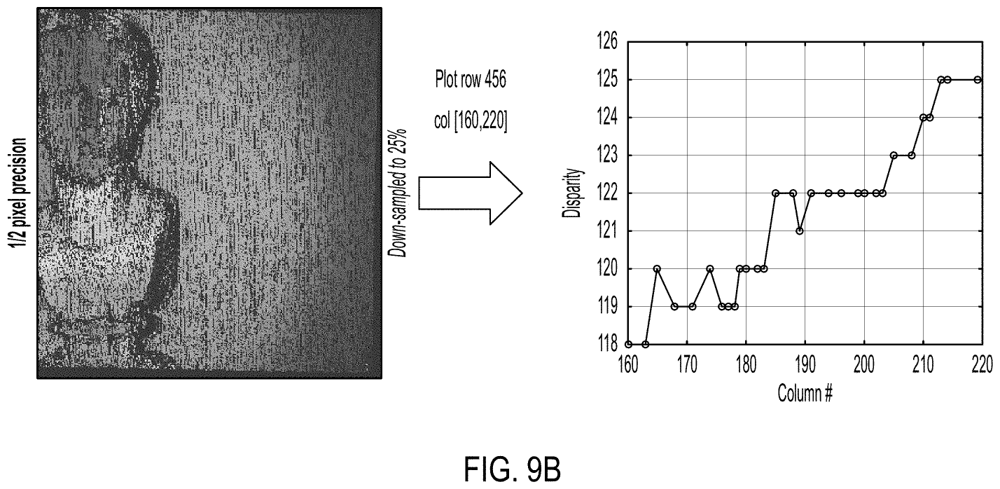

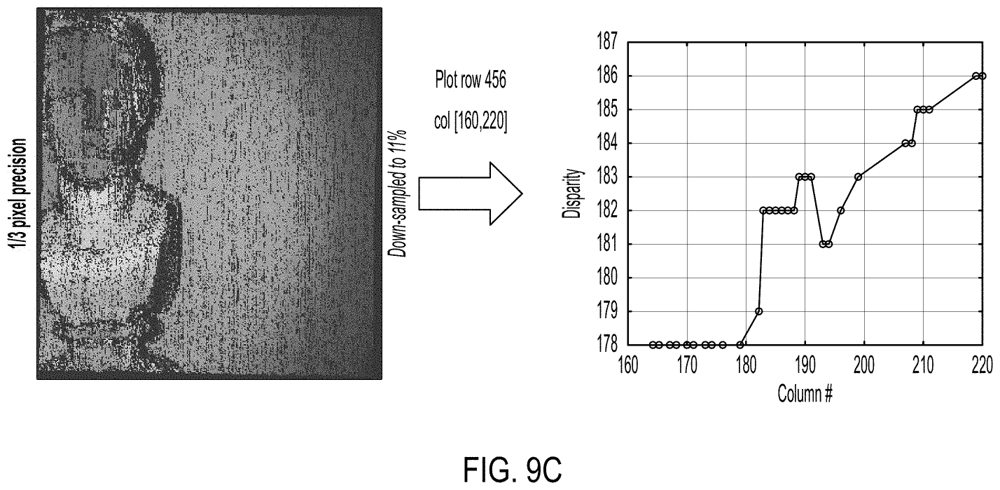

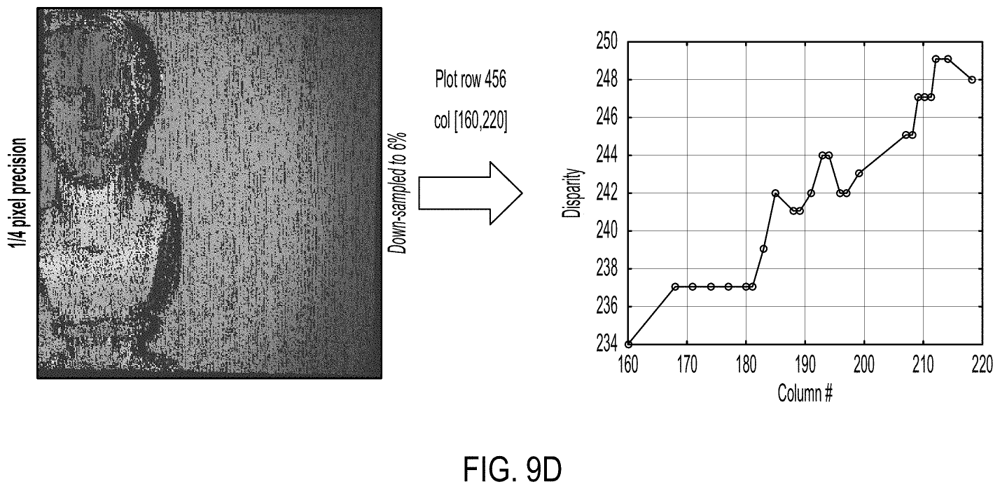

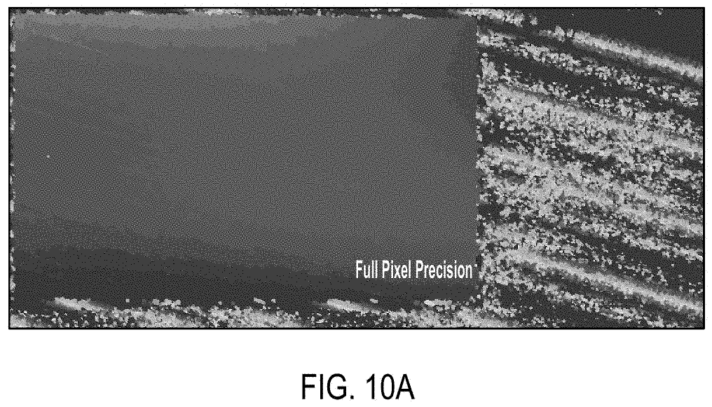

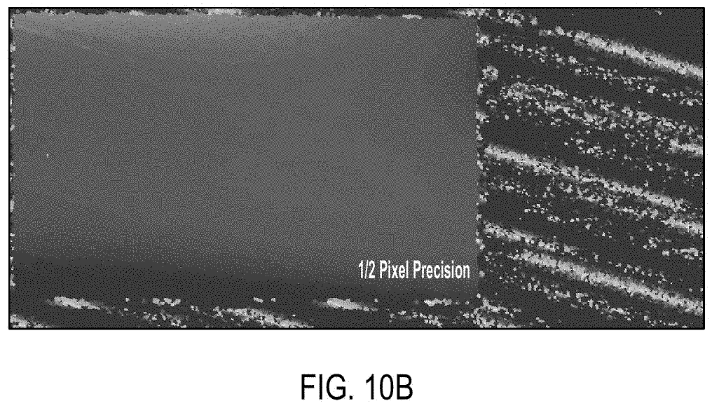

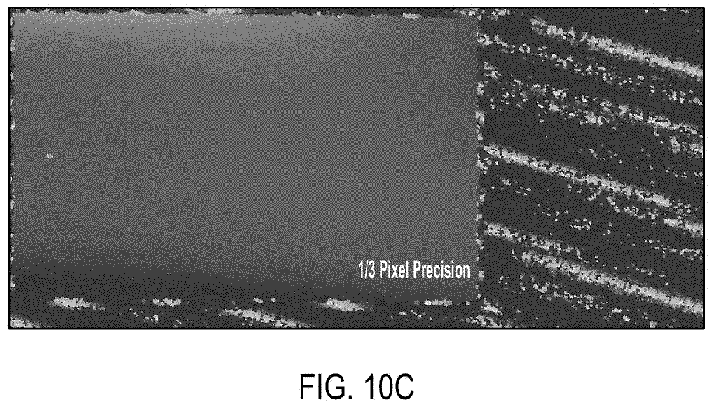

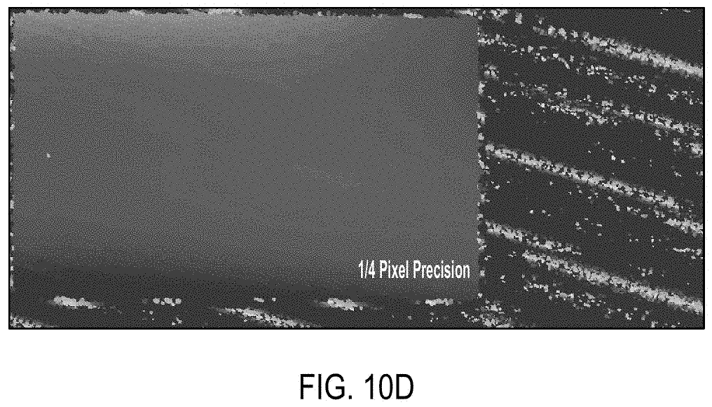

As can be seen by comparing FIGS. 8A and 8B, the boundaries of the blocks of pixels corresponding to the projected dots are cleaned up. That is, incorrectly identified pixels are able to be either removed or renumbered to be correctly identified. Accordingly, the structured-light-based system is able to achieve higher depth resolution with decreased depth error. Examples of different degrees to which the higher depth resolution may be achieved are shown in FIGS. 9A-9D and FIGS. 10A-D.

FIG. 9A depicts a depth map resulting from depth calculation of the image of FIG. 7 by a conventional structured-light-based system, and depicts a corresponding graph showing the calculated disparity for a plurality of pixels in a selected row, according to a comparative example. FIGS. 9B-9D each depict a depth map resulting from depth calculation of the image of FIG. 7 by a structured-light-based system, and depict a corresponding graph showing the calculated disparity for a plurality of pixels in the selected row, according to embodiments of the present disclosure.

Referring to FIG. 9A, the depth map depicts one-pixel precision that is non-super resolution (e.g., as may be achieved using the SL ISP pipeline 400 of the conventional structured-light-based system shown in FIG. 4A). As shown in the graph of FIG. 9A, a small region was chosen for analysis and comparison of the comparative example of FIG. 9A and the examples of embodiments of the present disclosure of FIGS. 9B-9D (e.g., pixels corresponding to row 456 and columns 160-220). The small region that was chosen was the pixels found in the 456th row, and in columns 160-220.

Accordingly, the x-axis of the graph indicates the pixels of row 456 by their respective column, and the y-axis of the graph indicates the disparity of the pixels. In FIG. 9A, the measure of disparity ranges from 59-63, with no half level being detectable.

Referring to FIG. 9B, an example of an embodiment of the present disclosure achieves ½-pixel precision (e.g., by using the dot localization and segmentation method described with respect to FIGS. 6A-6D). ½-pixel precision was achieved by enlarging the image 710 by 2 times, and the image 710 was down-sampled to a quarter of the original size (e.g., during resampling, subsampling, or denoising the image (420) of the SL ISP pipeline 400). Without down-sampling, the analyzed image would have been 4 times larger than the analyzed image corresponding to FIG. 9A. Accordingly, the range of disparity is doubled from that in FIG. 9A. That is, the disparity range of 59-63 of FIG. 9A is doubled to a disparity range of 118-126 in FIG. 9B, according to the present embodiment.

The examples shown in FIGS. 9C and 9D are able to achieve in greater depth resolution in the same general manner as achieved in the example FIG. 9B, albeit while enlarging the image 710 and down-sampling of the image 710 to different degrees than the example of FIG. 9B.

Referring to FIG. 9C, an example of an embodiment of the present disclosure achieves ⅓-pixel precision by enlarging the image 710 by 3 times, and by down-sampling the image 710 to 11% of the original size. Accordingly, the disparity range is increased over that of the example of FIG. 9B (e.g., to 3 times that of the comparative example of FIG. 9A).

Further, referring to FIG. 9D, an embodiment of the present disclosure achieves ¼-pixel precision. By enlarging the image 710 by 4 times, and by down-sampling the image 710 to 6% of the original size. Accordingly, the disparity range is increased over that of the example of FIG. 9C (e.g., to 4 times that of the comparative example of FIG. 9A).

FIG. 10A depicts a depth map resulting from depth calculation of an image of a flat board by a conventional structured-light-based system, according to a comparative example, and FIGS. 10B-10D each depict a depth map resulting from depth calculation of the same image of the flat board by a structured-light-based system, according to embodiments of the present disclosure.

In a manner paralleling FIGS. 9A-9D, FIGS. 10A-10D respectively show one-pixel precision, ½-pixel precision, ⅓-pixel precision, and ¼-pixel precision. As can be seen by comparing FIGS. 10B-10D to FIG. 10A, embodiments of the present disclosure provide increased depth resolution while decreasing depth error. It should be noted that, although three examples of subpixel resolution are shown in FIGS. 9B-9D and 10B-10D, arbitrary subpixel accuracy is supported by the embodiments of the present disclosure (e.g., subpixel accuracy corresponding to 1/100-pixel precision or better).

According to the embodiments of the present disclosure described above, the disclosed embodiments enable existing structured-light image signal processing (SL ISP) to be modified to allow for subpixel accuracy. The disclosed embodiments may be achieved by simply adding a single major module (e.g., the “dot localization and segmentation” module 448 described with respect to FIGS. 6A-6D). The dot localization and segmentation module 448 may be added between the modules for patch classification (440) and disparity estimate (450) of the SL ISP pipeline 400 of the conventional structured-light-based system shown in FIG. 4A).

The complexity of an algorithm corresponding to the dot localization and segmentation module 448 may be represented by O(r*N), where r is the projected dot size, and N is the number of pixels. Further, an equivalent to 3˜4 r×r linear filters may be used to implement the dot localization and segmentation module 448, where r×r corresponds to the size of the block of pixels (e.g., r is 3 in the example described with respect to FIGS. 6A-6D). Moreover, the dot localization and segmentation module 448 may be added to the SL ISP pipeline 400 of the conventional structured-light-based system with little to no change of the other existing modules (e.g., the modules 410-495 shown in FIG. 4A).

Accordingly, the disclosed embodiments provide improvements to the field of display technology by providing a structured-light-based system and method that is able to achieve 3D imaging with increased resolution and decreased depth error.

In the description, for the purposes of explanation, numerous specific details provide a thorough understanding of various embodiments. It is apparent, however, that various embodiments may be practiced without these specific details or with one or more equivalent arrangements. In other instances, well-known structures and devices are shown in block diagram form in order to avoid unnecessarily obscuring various embodiments.

The terminology used herein is for the purpose of describing particular embodiments only and is not intended to be limiting of the present disclosure. As used herein, the singular forms “a” and “an” are intended to include the plural forms as well, unless the context clearly indicates otherwise. It will be further understood that the terms “comprises,” “comprising,” “have,” “having,” “includes,” and “including,” when used in this specification, specify the presence of the stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

When a certain embodiment may be implemented differently, a specific process order may be performed differently from the described order. For example, two consecutively described processes may be performed substantially at the same time or performed in an order opposite to the described order.

The electronic or electric devices and/or any other relevant devices or components according to embodiments of the present disclosure described herein may be implemented utilizing any suitable hardware, firmware (e.g., an application-specific integrated circuit), software, or a combination of software, firmware, and hardware. For example, the various components of these devices may be formed on one integrated circuit (IC) chip or on separate IC chips. Further, the various components of these devices may be implemented on a flexible printed circuit film, a tape carrier package (TCP), a printed circuit board (PCB), or formed on one substrate. Further, the various components of these devices may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the spirit and scope of the embodiments of the present disclosure.

Unless otherwise defined, all terms (including technical and scientific terms) used herein have the same meaning as commonly understood by one of ordinary skill in the art to which the present inventive concept belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

Embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise for example indicated. Accordingly, it will be understood by those of skill in the art that various changes in form and details may be made without departing from the spirit and scope of the present disclosure as set forth in the following claims, with functional equivalents thereof to be included therein.

What is claimed is:

1. A structured-light three-dimensional sensing system comprising:
a light projector configured to project a plurality of dots onto an object, the dots collectively forming a structured light pattern comprising multiple unique patterns;
an image sensor configured to capture an image of the object with the dots projected thereon;
a patch classifier configured to:
analyze the image to recognize the dots;
perceive the unique patterns of the structured light pattern based on the recognized dots;
associate each pixel of the image with a respective portion of a corresponding one of the unique patterns; and
assign a class ID and a subclass ID to each of the pixels of the image based on the perceived unique patterns, the class ID representing a respective unique pattern, and the subclass ID representing a respective portion of the unique pattern;
a dot localizer configured to:
for each pixel, count a number of neighboring pixels having the same assigned class ID as the pixel;
for each class ID, determine the pixel having a greatest number of neighboring pixels having the same assigned class ID as being a center pixel corresponding to a center of a corresponding dot; and
for each pixel belonging to a dot, re-arranging according to the pixel's sub-class ID; and
a depth estimator configured to determine a disparity of each dot from a respective reference point of the dot, and to estimate a depth of a feature of the object based on the determined disparity.

2. The structured-light three-dimensional sensing system of claim 1, wherein the dot localizer is further configured to:
associate the center pixel with a respective N×N block of pixels; and
reassign the class ID of each of the pixels of the block to match the class ID of the center pixel.

3. The structured-light three-dimensional sensing system of claim 2, wherein the dot localizer is further configured to reassign the subclass ID to each of the pixels of the block of pixels based on its position in the block of pixels, and based on an order of the portions of the unique pattern represented by the class ID of the center pixel.

4. The structured-light three-dimensional sensing system of claim 1, wherein the structured light pattern comprises 192 unique patterns, or 1024 unique patterns, or other configuration.

5. The structured-light three-dimensional sensing system of claim 1, wherein each block of pixels comprises a unique patch size of 3×3 pixels, or 4×4 pixels, or other configuration.

6. The structured-light three-dimensional sensing system of claim 1, wherein the light projector is at a fixed baseline distance from the image sensor.

7. The structured-light three-dimensional sensing system of claim 1, wherein the dot localizer is between the patch classifier and the depth estimator.

8. A method of 3D imaging using a structured-light three-dimensional sensing system, the method comprising:
projecting, with a light projector, a plurality of dots onto an object, the dots collectively forming a structured light pattern comprising multiple unique patterns;
capturing, an image sensor, an image of the object with the dots projected thereon;
for each pixel, counting, with a dot localizer, a number of neighboring pixels having a same assigned class ID as the pixel;
for each class ID, determining, with the dot localizer, the pixel having a greatest number of neighboring pixels having the same assigned class ID as being a center pixel corresponding to a center of a corresponding dot; and
for each pixel belonging to a dot, re-arranging, with the dot localizer, according to the pixel's sub-class ID.

9. The method of claim 8, further comprising:
associating, with the dot localizer, the center pixel with a respective N×N block of pixels; and
reassigning, with the dot localizer, the class ID of each of the pixels of the block to match the class ID of the center pixel.

10. The method of claim 9, further comprising reassigning, with the dot localizer, a subclass ID to each of the pixels of the block of pixels based on its position in the block of pixels, and based on an order of portions of the unique pattern represented by the class ID of the center pixel.

11. The method of claim 8, wherein the structured light pattern comprises 192 unique patterns, or 1024 unique patterns, or other configuration.

12. The method of claim 8, wherein each block of pixels comprises a unique patch size of 3×3 pixels, or 4×4 pixels, or other configuration.

13. The method of claim 8, wherein the light projector is at a fixed baseline distance from the image sensor.

14. The method of claim 13, further comprising estimating, with a depth estimator, a depth according to the equation Z=B×F/(P×D), wherein Z is the depth, B is a baseline distance between the light projector and the image sensor, F is a focal length of the image sensor, P is a pixel pitch, and D is a disparity.

15. A non-transitory computer readable medium implemented on a structured-light three-dimensional sensing system; the non-transitory computer readable medium having computer code that; when executed on a processor; implements a method of 3D imaging using the structured-light three-dimensional sensing system; the method comprising:
projecting, with a light projector, a plurality of dots onto an object, the dots collectively forming a structured light pattern comprising multiple unique patterns;
capturing, an image sensor, an image of the object with the dots projected thereon;
analyzing, with a patch classifier, the image to recognize the dots;
perceiving, with the patch classifier, the unique patterns of the structured light pattern based on the recognized dots;
associating, with the patch classifier, each pixel of the image with a respective portion of a corresponding one of the unique patterns;
assigning, with the patch classifier, a class ID and a subclass ID to each of the pixels of the image based on the perceived unique patterns, the class ID representing a respective unique pattern, and the subclass ID representing a respective portion of the unique pattern;
for each pixel, counting, with a dot localizer, a number of neighboring pixels having the same assigned class ID as the pixel;
for each class ID, determining, with the dot localizer, the pixel having a greatest number of neighboring pixels having the same assigned class ID as being a center pixel corresponding to a center of a corresponding dot; and
determining, with a depth estimator, a disparity of each dot from a respective reference point of the dot, and to estimate a depth of a feature of the object based on the determined disparity.

16. The non-transitory computer readable medium of claim 15, wherein the computer code, when executed by the processor, further implements the method of 3D imaging using the structured-light three-dimensional sensing system by:
associating, with the dot localizer, the center pixel with a respective N×N block of pixels; and
reassigning, with the dot localizer, the class ID of each of the pixels of the block to match the class ID of the center pixel.

17. The non-transitory computer readable medium of claim 16, wherein the computer code, when executed by the processor, further implements the method of 3D imaging using the structured-light three-dimensional sensing system by reassigning, with the dot localizer, the subclass ID to each of the pixels of the block of pixels based on its position in the block of pixels, and based on an order of the portions of the unique pattern represented by the class ID of the center pixel.

18. The non-transitory computer readable medium of claim 15, wherein the structured light pattern comprises 192 unique patterns, or 1024 unique patterns, or other configuration.

19. The non-transitory computer readable medium of claim 15, wherein each block of pixels comprises a unique patch size of 3×3 pixels, or 4×4 pixels, or other configuration.

20. The non-transitory computer readable medium of claim 15, wherein the light projector is at a fixed baseline distance from the image sensor.
